(19) United States
(12) Patent Application Publication
(10) Pub. No.: US 2021/0333736 A1
(43) Pub. Date: Oct. 28, 2021

(54) OPTICAL DENSITY ADJUSTMENT

(71) Applicant: HEWLETT-PACKARD DEVELOPMENT COMPANY, L.P., Spring, TX (US)

(72) Inventors: Guang Jin Li, San Diego, CA (US); Jin Zou, San Diego, CA (US)

(21) Appl. No.: 16/605,953

(22) PCT Filed: Apr. 30, 2018
(86) PCT No.: PCT/US2018/030164

§ 371 Date: Oct. 17, 2019

(51) Int. Cl. G03G 15/00; G03G 15/095

(52) U.S. Cl. CPC G03G 15/5041; G03G 15/095

(57) ABSTRACT

In one example of the disclosure, a first voltage is provided to an electrode of a development assembly during a first printing operation. The developer assembly includes a current-resistant coating and is to develop print fluid with conductive particles. Contemporaneous with the providing of the first voltage to the electrode, a second voltage is provided to a squeegee roller of the developer assembly. Data indicative of a measurement of optical density of a first image printed utilizing the developer assembly is received. During a second printing operation, if the measured optical density is outside a target optical density, contemporaneously the first voltage is provided to the electrode and a third voltage to the squeegee roller to adjust image optical density.

### BACKGROUND

Images and text may be formed on a substrate using a photoconductive element. Print substances may be transferred to and from the photoconductive element using charged surfaces and/or rollers and/or by forming electric fields between surfaces and/or rollers. Such methods may be referred to as electrophotography. Among the types of electrophotography, liquid print substance-based electrophotography (also known as “LEP printing”) may allow formation of images and/or text using chargeable particles.

### DRAWINGS

FIG. 1 illustrates an example of a system for optical density adjustment that includes a developer assembly with a current-resistant coating.

FIG. 2 illustrates an example of a system for optical density adjustment at a printer system, the printer system including a developer assembly with a current-resistant coating.

FIG. 3 is a block diagram depicting a memory resource and a processing resource to implement an example of a method for optical density adjustment.

FIG. 4 illustrates an example of a system for optical density adjustment, wherein the system includes a developer assembly having a current-resistant coating, an electrode, a squeegee roller, and a developer roller.

FIG. 5 is a schematic diagram showing a cross section of an example LEP printer implementing the system for optical density adjustment according to an example of the principles described herein.

FIG. 6 is a flow diagram depicting an example implementation of a method for optical density adjustment utilizing a developer assembly with a current-resistant coating.

### DETAILED DESCRIPTION

In an example of LEP printing, a printer system may form an image on a print substrate by placing an electrostatic charge on a photoconductive element, and then utilizing a laser scanning unit to apply an electrostatic pattern of the desired image on the photoconductive element to selectively discharge the photoconductive element. The selective discharging forms a latent electrostatic image on the photoconductive element. The printer system includes a development station to develop the latent image into a visible image by applying a thin layer of electrostatic print fluid (which may be generally referred to as “LEP print fluid”, or “electronic print fluid”, “LEP ink”, or “electronic ink” in some examples) to the patterned photoconductive element. Charged particles (sometimes referred to herein as “print fluid particles” or “colorant particles”) in the LEP print fluid adhere to the electrostatic pattern on the photoconductive element to form a print fluid image. In examples, the print fluid image, including colorant particles and carrier fluid, is transferred utilizing a combination of heat and pressure from the photoconductive element to an intermediate transfer member (referred herein as a “blanket”) attached to a rotatable blanket drum. The blanket is heated until carrier fluid evaporates and colorant particles melt, and a resulting molten film representative of the image is then applied to the surface of the print substrate via pressure and tackiness. In examples the blanket that is attached to the blanket drum is a consumable or replaceable blanket.

For printing with colored print fluids, the printer system may include a separate development station for each of the various colored print fluids. There are typically two process methods for transferring a colored image from the photoreceptor to the substrate. One method is a multi-shot process method in which the process described in the preceding paragraph is repeated a distinct printing separation for each color, and each color is transferred sequentially in distinct passes from the blanket to the substrate until a full image is achieved. With multi-shot printing, for each separation a molten film (with one color) is applied to the surface of the print substrate. A second method is a one-shot process in which multiple color separations are acquired on the blanket via multiple applications (each with one color) from the photoconductive element to the blanket, and then the acquired color separations are transferred in one pass as a molten film from the blanket to the substrate.

In certain instances it may be desirable to utilize LEP printing processes to form images having a metallic aspect, including, but not limited to silver or gold hue. In one case, for example, a silver hued print fluid may include flakes of aluminum (Al) as part of the solids contained in the print fluid. In other examples, a metallic print fluid may include, but are not limited to, actual silver (Ag) or gold (Au) metal flakes. As opposed to ordinary CMYK print fluids (which pigments typically are very small in size and encapsulated in polymeric resins to make them non-conductive), the metallic print fluids may be highly conductive due to the presence of metallic particles. The presence of the large and highly conductive flakes in metallic printing fluids presents a major challenge for LEP printing, as the metal flakes can cause electrical shorts to occur during printing. The highly conductive metal flakes can cause shorts between a developer roller and photoconductive drum surface. Such shorting can cause loss of electric field, which can induce transfer print fluid failures such as background and low optical density. Further, the highly conductive metal flakes can cause developer assembly power supply failures due to high current at nips of developer roller and other metal rollers (such as squeegee and cleaner roller). As used herein, “background” refers generally to the presence of metallic particles or flakes in a printed image in areas of the printed image that are not intended to have the metallic print fluid or flakes. As used herein, “optical density” refers generally to a measurement of a degree to which a refractive medium, e.g., a printed image, retards transmitted rays of light. In examples optical density of a printed image may be measured utilizing a spectrometer or a densimeter. In certain situations, with other factors being equal, a change in a thickness of a layer of an opaque print fluid applied to a substrate may have a direct effect up on optical density of the image.

To combat the above-described shorting and power supply issues, certain developer assemblies have designs where current-resistive coatings are used for various developer assembly components (e.g., the developer roller, squeegee roller and/or cleaner roller). In examples, a developer assembly for printing with print fluid with highly conductive particles may have a developer roller, squeegee roller, and/or cleaner roller that has a conductive first layer (e.g., a rubber layer having an ionic conductor) and a current-resistant second layer that is an outer layer relative to the first layer and that includes a non-conductive coating on an outer surface.

While the recent development of resistive coatings on developer assembly conductive roller surfaces (e.g., developer roller, squeegee roller, and/or cleaner roller) have significantly improved shorting and power supply issues in LEP printing utilizing print fluids with metallic particles, the overall background level in many applications has still been high relative to conventional CMYK printing. An existing method for managing the background levels at an acceptable range has been to attempt create a thinner than conventional in layer (e.g., thinner than a print fluid layer for conventional CMYK printing) at a developer roller so as to have an image with lower optical density. However, images printed with thinner layer metallic print fluids in this manner are prone to other print quality issues such as flow streaks and ghosts. In certain situations, background can increase exponentially with increases in optical density, and this issue can be exacerbated when utilizing aged print fluid. Using conventional color calibration methods for printing using print fluids with metallic particles, it has been challenging to keep image background within specification while keeping an optical density at an acceptable level that less sensitive to the flow streaks and ghost print quality issues.

To address these issues, various examples described in more detail below provide a system and a method that enables adjustment of optical density of printed images by utilizing squeegee voltages instead of using electrode voltages to adjust print fluid layer thickness at the developer assembly. With the disclosed examples, it is possible to utilize a developer assembly with current-resistant coatings to adjust optical density of images printed with print fluids having metallic particles to an optical density level that results high print quality (e.g., printed images with acceptable background in conjunction with a lack of flow streaks and ghost).

In an example of the disclosure, a method to adjust optical density includes providing, during a first printing operation, a first voltage to an electrode of a development assembly. The developer assembly includes a current-resistant coating and is to develop print fluid with conductive particles.

In examples, the conductive particles within the print fluid are metal flakes, e.g., aluminum, silver or gold flakes. In examples, the current-resistant coating of the developer assembly may be a ceramic material coating of one or more of a squeegee roller and a cleaner roller. In other examples, the current-resistant coating of the developer assembly may be a polymeric coating of a developer roller.

Contemporaneous with the providing of the first voltage to the electrode, a second voltage is provided to a squeegee roller of the developer assembly. Data indicative of a measurement of optical density of a first image printed utilizing the developer assembly is received. During a second printing operation, if the measured optical density is outside a target optical density, the first voltage is provided to the electrode contemporaneous with providing a third voltage to the squeegee roller to adjust image optical density. In examples, the received data indicative of a measurement of optical density of a first image printed utilizing the developer assembly is data that was captured utilizing a spectrometer or densimeter.

In examples, the first image is a test image and the contemporaneous provision of the first voltage and a third voltage are to adjust image optical density of a second image that is a production image printed during the second printing operation. In other examples, the first image is a production image and the contemporaneous provision of the first voltage and a third voltage are to adjust image optical density of the first image as printed again during the second printing operation.

In examples, the second voltage that is provided to the squeegee roller is less than the first voltage that is provided to the electrode. In certain examples, the first voltage provided to the electrode is to be between 300V and 500V, and the third voltage to be provided to the squeegee roller as an adjustment voltage is between 200V and 450V. Examples of the disclosure include determining prescribed amounts for the first voltage and the third voltage by accessing a lookup table or other database that associates combinations of voltages to be concurrently provided to electrodes and squeegee rollers with target optical densities.

In examples, the change in voltage provided to the squeegee roller from the second voltage to the third voltage is to cause a change in background level of printed images. In a particular example, in response to receipt of data indicative that a measurement of background error detected in the printed first image is greater than a background tolerance level, the first voltage to the electrode contemporaneous with provision of the third voltage to the squeegee roller to adjust background level. In yet another particular example of the disclosure, prescribed voltage amounts for the first voltage and the third voltage are determined by accessing a database that associates combinations of voltages to be concurrently provided to electrodes and squeegee rollers with target background levels.

In this manner the disclosed apparatus and method enables LEP printing with print fluids having metallic particles such that image background levels remain within specification while keeping an optical density at an acceptable level (1.2 in certain examples) that less sensitive to the flow streaks and ghost print quality issues. Users and providers of LEP printer systems will appreciate that, when utilizing the disclosed examples, background level of the images printed with print fluids having metallic particles will be reduced with less sensitivity to variations in print fluid layer thickness and print fluid age. Installations and utilization of LEP printers that include the disclosed apparatus and methods should thereby be enhanced.

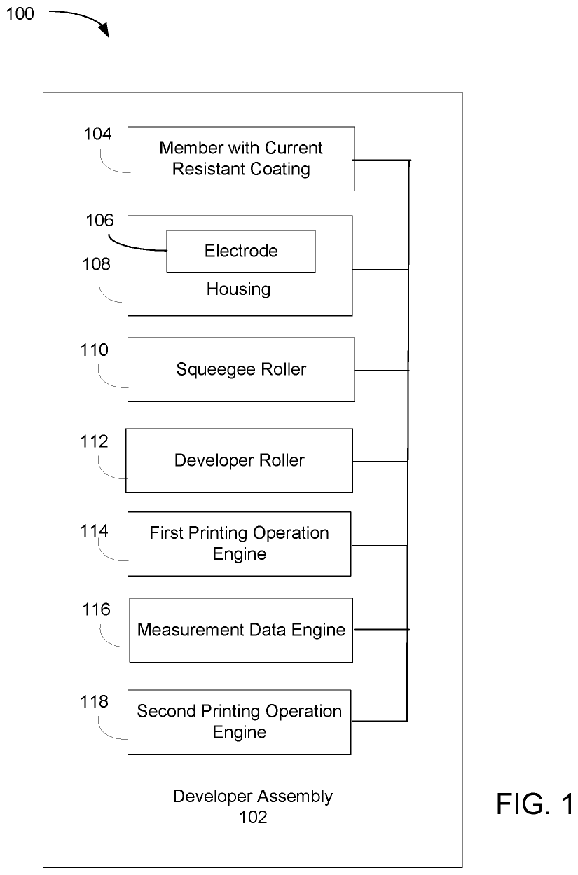

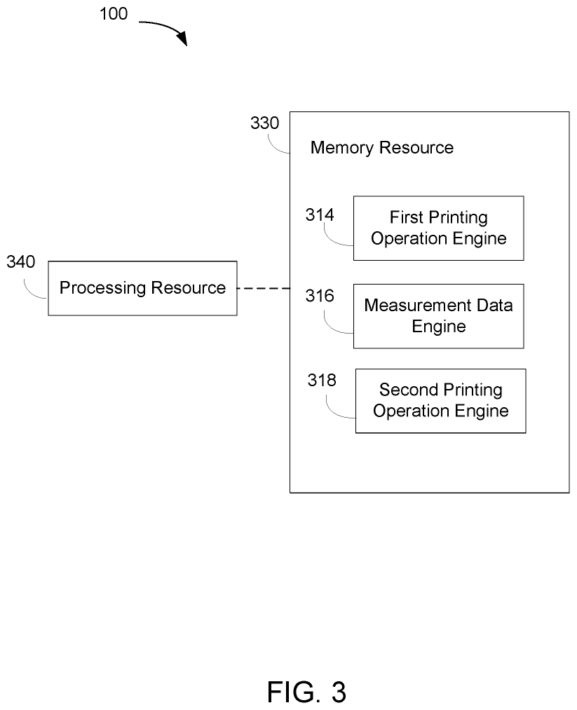

FIGS. 1-5 depict examples of physical and logical components for implementing various examples. In FIGS. 1-5 various components are identified as engines 114, 116, and 118. In describing engines 114, 116, and 118 focus is on each engine's designated function. However, the term engine, as used herein, refers generally to hardware and/or programming to perform a designated function. As is illustrated later with respect to FIG. 3, the hardware of each engine, for example, may include one or both of a processor and a memory, while the programming may be code stored on that memory and executable by the processor to perform the designated function.

FIG. 1 illustrates an example of a system 100 for optical density adjustment. In this example, system 100 includes a developer assembly 102, with developer assembly 102 including a member with a current-resistant coating 104, a housing 108, with an electrode 106 disposed within the housing, a squeegee roller 110 a developer roller 112, a first printing operation engine 114, a measurement data engine 116, and a second printing operation engine 118. In performing their respective functions, first printing operation engine 114, a measurement data engine 116, and a second printing operation engine 118 may access a data repository, e.g., a memory accessible to system 100 that can be used to store and retrieve data.

In the example of FIG. 1, system 100 includes a developer assembly 102 for developing print fluid with highly conductive particles and applying a layer of the print fluid upon a charged photoconductive element. The application of the print fluid from developer assembly 102 the photoconductive element is to develop a latent image on the photoconductive element into a visible print fluid image.

Developer assembly 102 includes a housing 108, with an electrode 106 disposed within the housing. In examples, housing 108 may include metal and/or plastic components. Electrode 106 is to create an electric field between the electrode 106 and a developer roller 112 of the developer assembly 102, the electric field to attract particles within the print fluid to the surface of developer roller 112. In certain embodiments, developer assembly 102 may include two or more electrodes 106.

Continuing with the example of FIG. 1, developer assembly 102 includes a developer roller 112 and a squeegee roller 110. Developer roller 112 is to form a nip with a photoconductive element (e.g., a photoconductor drum) of a printer system so as to transfer print fluid with conductive particles onto a latent image area of the photoconductive element. In this example the conductive particles are metal flakes (which may include, but are not limited to aluminum, silver, or gold flakes). Squeegee roller 110 is disposed adjoining a surface of developer roller 112 and is to create an electric field between the squeegee roller and developer roller 112 to pack particles within the ink fluid onto the developer roller, and is to contemporaneously, with the developer roller 112, create a mechanical force to squeeze out excess carrier fluid.

In this example, developer assembly 102 includes at least one member with a current-resistant coating. In an example, the member may be developer roller 112. The current-resistant coating at developer assembly 102 may be or include, but is not limited to, a polymeric coating at developer roller 12. In an example, the member with the current-resistant coating may be squeegee roller 110 or a cleaner roller (not pictured in FIG. 1). The current-resistant coating at developer assembly 102 may be or include, but is not limited to, a ceramic coating or a polymeric coating at squeegee roller 110 or the cleaner roller. As used herein, “cleaner roller” refers generally to a component at developer assembly 102 that is to create an electric field between the cleaner roller and developer roller 112 to attract leftover print fluid particles from the developer roller 112 onto the cleaner roller. In a particular example, the cleaner roller is in turn scrubbed with a sponge roller disposed against the cleaner roller, and excess print fluid left after the scrubbing is scraped off the cleaner roller by a blade disposed against the cleaner roller.

First printing operation engine 114 represents generally a combination of hardware and programming to cause a contemporaneous provision of a first voltage to electrode 106 and a provision of a second voltage to squeegee roller 110. The voltage may be provided by any power source or combination of power sources. In examples, the second voltage is to be less than the first voltage as this arrangement can result in less background and higher print quality. In certain examples, the first voltage is between 300V and 500V, with the second voltage being between 200V and 450V.

Continuing with the example of FIG. 1, measurement data engine 116 represents generally a combination of hardware and programming to receive data indicative of a measurement of optical density of a first image that was printed utilizing developer assembly 102. In examples, the data may be data that was created or captured utilizing a spectrometer or a densimeter. In some examples, the spectrometer or densimeter may a device that is inline at a printer system. As used herein, “inline” refers generally to the spectrometer or densimeter being located in the media path of the printer system. In some examples, the inline spectrometer or densimeter may be situated in the substrate path of the printer system at a point after the creation of printouts, and before any post-printing activities such as laminating, winding (in the case of sheet fed substrate) or stacking (in the case of sheet substrate). In examples, the inline spectrometer or densimeter may be one that is also utilized for image registration analysis, e.g. in guiding placement of images relative to each other or guiding placement of images relative to an edge or fiducial on a substrate.

Second printing operation engine 118 represents generally a combination of hardware and programming to, if the measured optical density is outside a target optical density, contemporaneously provide the first voltage to electrode 106 and provide a third voltage to squeegee roller 110 to adjust image optical density. In examples, the third voltage is to be less than the first voltage and may be between 200V and 450V. In certain examples second printing operation engine 118 may determine prescribed amounts for the first voltage and the third voltage. In certain examples, the determining of a prescribed amount for the third voltage may include accessing a lookup table or other database that includes a list of combinations or associations of squeegee roller voltages and electrode voltages to achieve target optical densities.

In other examples, the change in voltage provided to squeegee roller 110 from the second voltage to the third voltage is to cause a change in background level in images printed utilizing developer assembly 102. In examples, second printing operation engine 118 may, in response to receipt of data indicative that a measurement of background error detected in the printed first image is greater than a background tolerance level, contemporaneously provide the first voltage to the electrode and a third voltage to the squeegee roller to adjust background level. In certain examples, the determining of a prescribed amount for the third voltage may include accessing a lookup table or other database that includes associations or combinations of squeegee roller voltages and electrode voltages to achieve target background levels.

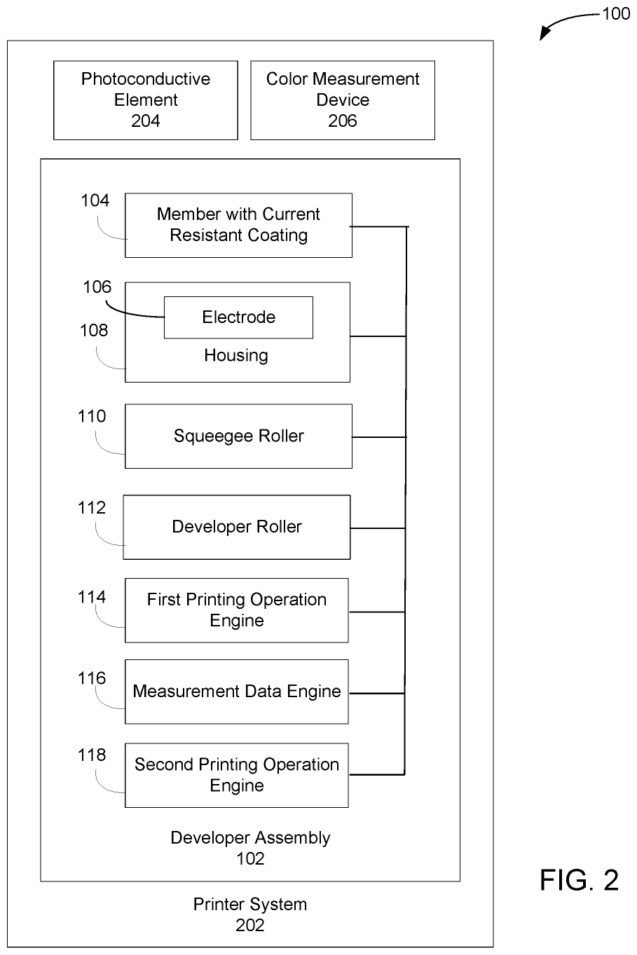

FIG. 2 illustrates another example of system 100 for optical density adjustment. As in FIG. 1, printer system 100 includes a developer assembly 102, with the developer assembly including a member with a current-resistant coating 104, a housing 108, with an electrode 106 disposed within the housing, a squeegee roller 110 a developer roller 112, a first printing operation engine 114, a measurement data engine 116, and a second printing operation engine 118. Printer system 202 of FIG. 2 additionally includes a photoconductive element 204 and a color measurement device.

In the example of FIG. 2, photoconductive element 204, also sometimes referred to as a “photo imaging plate” or “PIP”, may be mounted on a cylinder to such that a clean, bare photoconductive element segment rotates under a charging device such as a charge roller, corona wire or scorotron. The charging device may generate electrical charges which flow towards the photoconductive element 204 surface and cover it with a uniform static charge. As the photoconductive element cylinder continues to rotate, it passes the imaging unit where laser beams expose the image area, dissipating (neutralizing) the charge in those areas. When the exposed photoconductive element 204 rotates toward developer assembly 102 it is carrying a ‘latent image’ in the form of an invisible electrostatic charge pattern that replicates the image to be printed. Next, the print fluid is applied to the photoconductive element 204 using developer assembly 102, as described above with respect to FIG. 1. is manner the disclosed apparatus and method enables LEP printing with print fluids having metallic particles such that image background levels remain within specification while keeping an optical density at an acceptable level (1.2 in certain examples) that less sensitive to the flow streaks and ghost print quality issues. Users and providers of LEP printer systems will appreciate that, when utilizing the disclosed examples, background level of the images printed with print fluids having metallic particles will be reduced with less sensitivity to variations in print fluid layer thickness and print fluid age.

First printing operation engine 114, measurement data engine 116, and second printing operation engine 118 control aspects of the movement of print fluid within developer assembly 102. First printing operation engine 114 represents generally a combination of hardware and programming to cause, at developer assembly 102, a contemporaneous provision of a first voltage to electrode 106 and a provision of a second voltage to squeegee roller 110. Measurement data engine 116 represents generally a combination of hardware and programming to receive data indicative of a measurement of optical density of a first image printed utilizing developer assembly 102. Second printing operation engine 118 is to, if the optical density measured by color measurement device 206 is outside a target optical density, contemporaneously provide the first voltage to the electrode and provide a third voltage to squeegee roller 110 to adjust image optical density.

In examples, the data received by measurement data engine 116 is data that was created at, captured by, or originated at color measurement device 206. Color measurement system 206 is to create or capture data that is indicative of a measurement of optical density of a printed image that was printed utilizing printer system 202 and developer assembly 102. In examples, color measurement device 206 may be a spectrometer or a densimeter. In examples, color measurement device 206 is a device that is inline at a printer system 202.

In example, following a transfer of print fluid from squeegee roller 110 of developer assembly 102 to photoconductive element 204, the photoconductive element 204 rotates into contact with the electrically charged blanket on the transfer cylinder, and the print fluid layer is electrically transferred to the blanket (also commonly referred to as an intermediate transfer member. The blanket is to then effect a transfer of the print fluid layer to a substrate. In another example, a printer system may not include a blanket/intermediate transfer member, such that the photoconductive element 204 may rotate into direct contact with a substrate.

In the foregoing discussion of FIGS. 1 and 2, engines 114, 116, and 118 were described as combinations of hardware and programming. Engines 114, 116, and 118 may be implemented in a number of fashions. Looking at FIG. 3 the programming may be processor executable instructions stored on a tangible memory resource 330 and the hardware may include a processing resource 340 for executing those instructions. Thus, memory resource 330 can be said to store program instructions that when executed by processing resource 340 implement system 100 of FIGS. 1-5.

Memory resource 330 represents generally any number of memory components capable of storing instructions that can be executed by processing resource 340. Memory resource 330 is non-transitory in the sense that it does not encompass a transitory signal but instead is made up of a memory component or memory components to store the relevant instructions. Memory resource 330 may be implemented in a single device or distributed across devices. Likewise, processing resource 340 represents any number of processors capable of executing instructions stored by memory resource 330. Processing resource 340 may be integrated in a single device or distributed across devices. Further, memory resource 330 may be fully or partially integrated in the same device as processing resource 340, or it may be separate but accessible to that device and processing resource 340.

In one example, the program instructions can be part of an installation package that when installed can be executed by processing resource 340 to implement system 100. In this case, memory resource 330 may be a portable medium such as a CD, DVD, or flash drive or a memory maintained by a server from which the installation package can be downloaded and installed. In another example, the program instructions may be part of an application or applications already installed. Here, memory resource 330 can include integrated memory such as a hard drive, solid state drive, or the like.

In FIG. 3, the executable program instructions stored in memory resource 330 are depicted as first printing operation module 314, measurement data module 316, and second printing operation engine 318. First printing operation module 314 represents program instructions that when executed by processing resource 340 may perform any of the functionalities described above in relation to first printing operation engine 114 of FIGS. 1 and 2. Measurement data module 316 represents program instructions that when executed by processing resource 340 may perform any of the functionalities described above in relation to measurement data engine 116 of FIGS. 1 and 2. Second printing operation module 318 represents program instructions that when executed by processing resource 340 may perform any of the functionalities described above in relation to second printing operation engine 118 of FIGS. 1 and 2.

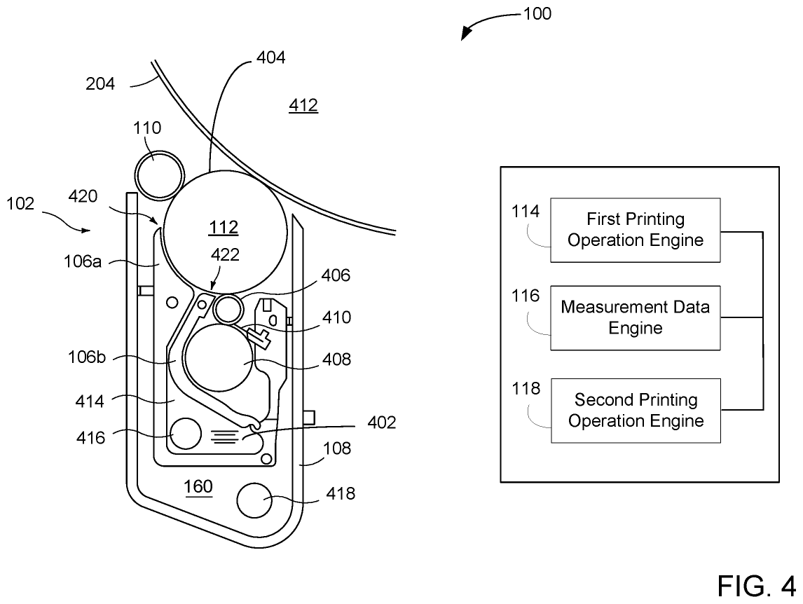

FIG. 4 illustrates an additional example of a system for optical density adjustment, wherein the system includes a developer assembly 102 having at least one element with a current-resistant coating, a first electrode 106a and a second electrode 106b disposed within a housing 108, a squeegee roller 110, a developer roller 112, a first printing operation engine 114, a measurement data engine 116, and a second printing operation engine 118. In performing their respective functions, first printing operation engine 114, a measurement data engine 116, and a second printing operation engine 118 may access a data repository, e.g., a memory accessible to system 100 that can be used to store and retrieve data.

Developer assembly 102 is for developing print fluid with highly conductive particles and applying a layer of the print fluid upon a charged photoconductive element. The application of the print fluid from developer assembly 102 to a photoconductive element 204 is to develop a latent image on the photoconductive element 204 into a visible print fluid image. In this example, photoconductive element 204 is attached to a rotatable drum 412. In examples, the latent image on photoconductive element 204 was created by utilizing a charging device to apply a polarity to photoconductive element 204 and utilizing a writing device to reverse or remove the polarity in specified areas to form the latent image on photoconductive element 204.

As the print fluid is pumped through a print fluid chamber 414 within housing 108 via a print fluid inlet 416 and a print fluid outlet 418, two electrodes, a first electrode 106a and a second electrode 106b, apply an electric field across two gaps 420 422. A first gap 420 is located between the first electrode 106a and the developer roller 112, and a second gap 422 is located between the second electrode 106b and the developer roller 112. The electric charge across these gaps 420 422 cause particles in the print fluid s to be attracted to a surface 404 of the charged developer roller 112.

Developer roller 112 is to form a nip with photoconductive element 204 so as to transfer print fluid with conductive particles onto the latent image area of the photoconductive element. In this example the conductive particles are metal flakes (which may include, but are not limited to aluminum, silver, or gold flakes).

Squeegee roller 110 is disposed adjoining a surface of developer roller 112 and is to create an electric field between the squeegee roller and developer roller 112 to pack particles within the ink fluid onto the developer roller, and is to contemporaneously, with developer roller 112, create a mechanical force to squeeze out excess carrier fluid.

Developer assembly 102 includes at least one member with a current-resistant coating. In the particular example of FIG. 4, developer roller 112 has a polymeric outer coating, and squeegee roller 110 and cleaner roller 406 have ceramic outer coatings, each of these coatings to resist electric current within developer assembly 102. In other examples, at least one, but not necessarily all, of developer roller 112, squeegee roller 110, and cleaner roller 406 will have a current-resistant coating.

Cleaner roller is to create an electric field between the cleaner roller and developer roller 112 to attract leftover print fluid particles from developer roller 112 onto the cleaner roller. In the example of FIG. 4, cleaner roller 406 is to in turn be scrubbed with a sponge roller 408 disposed against cleaner roller 406, and excess print fluid left after the scrubbing is to be scraped off cleaner roller 406 by a blade 410 disposed against the cleaner roller 406.

In this example, first printing operation engine 114 is to cause a power source to provide, contemporaneously, a first voltage to electrode 106 and a lesser second voltage to squeegee roller 110. Measurement data engine 116 is to receive data indicative of a measurement of optical density of a first image that was printed utilizing developer assembly 102. In examples, the data may be data that was created or captured utilizing a color measurement device such as a spectrometer or a densimeter. In some examples, color measurement device is a device that is inline at a printer system that includes developer assembly 102. Second printing operation engine 118 is to, if the measured optical density received by measurement data engine 116 is outside a target optical density, contemporaneously provide the first voltage to electrode 1069 and provide a third voltage, that is less than the first voltage, to squeegee roller 110 to adjust image optical density. In examples, the determining of a prescribed amount for the third voltage may include accessing a lookup table or other database that includes a list of combinations or associations of squeegee roller voltages and electrode voltages to achieve target optical densities.

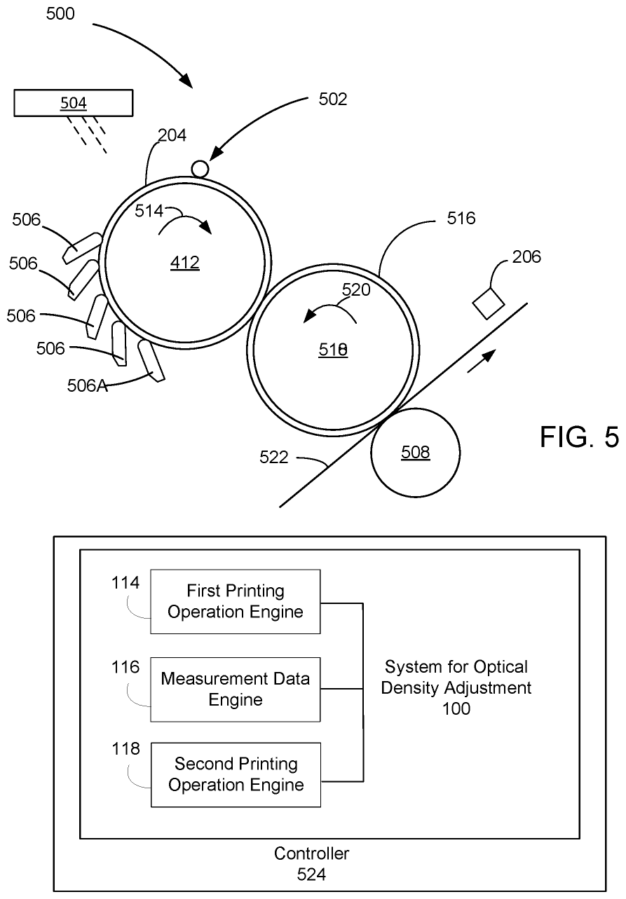

FIG. 5 is a schematic diagram showing a cross section of an example LEP printer that is to implement the system for optical density adjustment 100 according to an example of the principles described herein. Along with the elements previously described in connection with system for optical density adjustment 100 at FIGS. 1, 2, 3, and 4, LEP printer 500 may further include a charging element 502, an imaging unit 504, developer systems 506, and an impression cylinder 508.

According to the example of FIG. 5, a pattern of electrostatic charge is formed on a photoconductive element 204 by rotating a clean, bare segment of the photoconductive element 204 under a charging element 502. The photoconductive element 204 in this example is cylindrical in shape, e.g. is attached to a cylindrical drum 412, and rotates in a direction of arrow 514. In other examples, a photoconductive element may planar or part of a belt-driven system.

Charging element 502 may include a charging device, such as a charge roller, corona wire, scorotron, or any other charging device. A uniform static charge is deposited on the photoconductive element 204 by the charging element 502. As the photoconductive element 204 continues to rotate, it passes an imaging unit 504 where one or more laser beams dissipate localized charge in selected portions of the photoconductive element 204 to leave an invisible electrostatic charge pattern (“latent image”) that corresponds to the image to be printed. In some examples, the charging element 502 applies a negative charge to the surface of the photoconductive element 204. In other implementations, the charge is a positive charge. The imaging unit 504 then selectively discharges portions of the photoconductive element 204, resulting in local neutralized regions on the photoconductive element 204.

Continuing with the example of FIG. 5, developer assemblies 506 and 506a are disposed adjacent to the photoconductive element 204 and may correspond to various print fluid colors such as cyan, magenta, yellow, black, and the like. There may be one developer assembly 506 for each print fluid color. In other examples, e.g., black and white printing, a single developer assembly 506 may be included in LEP printer 500. In this example of FIG. 5, one of the illustrated developer systems 506A is the developer assembly 102 of system 100 as discussed with respect to FIGS. 1-4 herein. Developer assembly 506a is for development of print fluids with conductive metallic particles and is to have at least one member having a current-resistant coating. During printing, the appropriate developer assembly 506 506A is engaged with the photoconductive element 204. The engaged developer system 506 presents a uniform film of print fluid to the photoconductive element 204. The print fluid contains electrically-charged pigment particles which are attracted to the opposing charges on the image areas of the photoconductive element 204. As a result, the photoconductive element 204 has a developed image on its surface, i.e. a pattern of print fluid corresponding with the electrostatic charge pattern (also sometimes referred to as a “separation”).

The print fluid is transferred from the photoconductive element 204 to an intermediate transfer member blanket 516. The blanket may be in the form of a blanket attached to a rotatable drum 518. In other examples, the blanket may be in the form of a belt or other transfer system. In this particular example, the photoconductive element 204 and blanket 516 are on drums 412 518 that rotate relative to one another, such that the color separations are transferred during the relative rotation. In the example of FIG. 5, the blanket 516 rotates in the direction of arrow 520. The transfer of a developed image from the photoconductive element 204 to the blanket 516 may be known as the “first transfer”, which takes place at a point of engagement between the photoconductive element 204 and the blanket 516.

Once the layer of print fluid has been transferred to the blanket 516, it is next transferred to a print substrate 522. This transfer from the blanket 516 to the print substrate may be deemed the “second transfer”, which takes place at a point of engage between the blanket 516 and the print substrate 522. The impression cylinder 508 can both mechanically compress the print substrate 522 in to contact with the blanket 516 and also help feed the print substrate 522. In examples, the print substrate 522 may be a conductive or a non-conductive print substrate, including, but not limited to, paper, cardboard, sheets of metal, metal-coated paper, or metal-coated cardboard. In examples, the print substrate 522 with a printed image may be moved to a position to be scanned by an inline color measurement device 206, such as a spectrometer or densimeter, to generate optical density and/or background level data.

Controller 524 refers generally to any combination of hardware and software that is to control part, or all, of the LEP printer 500 print process. In examples, the controller 524 can control the voltage level applied by a voltage source, e.g., a power supply, to one or more of the imaging unit 504, the blanket 516, a drying unit, and other components of LEP printer 500. In this example controller 524 includes system 100 for optical density adjustment that is discussed in detail with respect to FIGS. 1-4 herein.

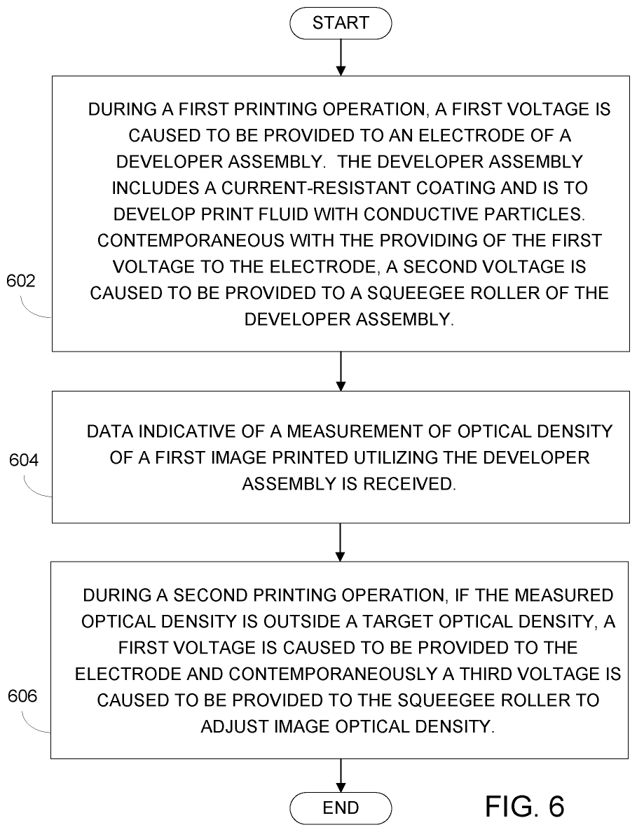

FIG. 6 is a flow diagram of implementation of a method for optical density adjustment during printing. In discussing FIG. 6, reference may be made to the components depicted in FIGS. 1, 2 and 3. Such reference is made to provide contextual examples and not to limit the manner in which the method depicted by FIG. 6 may be implemented. During a first printing operation, a first voltage is caused to be provided to an electrode of a developer assembly. The developer assembly includes a current-resistant coating and is to develop print fluid with conductive particles. Contemporaneous with the providing of the first voltage to the electrode, a second voltage is caused to be provided to a squeegee roller of the developer assembly (block 602). Referring back to FIGS. 1, 2, and 3 first printing operation engine 114 (FIGS. 1 and 2) or first printing operation module 314 (FIG. 3), when executed by processing resource 340, may be responsible for implementing block 602.

Data indicative of a measurement of optical density of a first image printed utilizing the developer assembly is received (block 604). Referring back to FIGS. 1, 2, and 3 measurement data engine 116 (FIGS. 1 and 2) or measurement data module 316 (FIG. 3), when executed by processing resource 340, may be responsible for implementing block 604.

During a second printing operation, if the measured optical density is outside a target optical density, a first voltage is caused to be provided to the electrode and contemporaneously a third voltage is caused to be provided to the squeegee roller to adjust image optical density (block 606). Referring back to FIGS. 1, 2, and 3 second printing operation engine 118 (FIGS. 1 and 2) or second printing operation module 318 (FIG. 3), when executed by processing resource 340, may be responsible for implementing block 606.

FIGS. 1-6 aid in depicting the architecture, functionality, and operation of various examples. In particular, FIGS. 1-5 depict various physical and logical components. Various components are defined at least in part as programs or programming. Each such component, portion thereof, or various combinations thereof may represent in whole or in part a module, segment, or portion of code that comprises executable instructions to implement any specified logical function(s). Each component or various combinations thereof may represent a circuit or a number of interconnected circuits to implement the specified logical function(s). Examples can be realized in a memory resource for use by or in connection with a processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is a non-transitory storage media that can contain, store, or maintain programs and data for use by or in connection with the instruction execution system. The term “non-transitory” is used only to clarify that the term media, as used herein, does not encompass a signal. Thus, the memory resource can comprise a physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory (EPROM), flash drives, and portable compact discs.

Although the flow diagram of FIG. 6 shows specific orders of execution, the order of execution may differ from that which is depicted. For example, the order of execution of two or more blocks or arrows may be scrambled relative to the order shown. Also, two or more blocks shown in succession may be executed concurrently or with partial concurrence. Such variations are within the scope of the present disclosure.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein. All of the features disclosed in this specification (including any accompanying claims, abstract and drawings), and/or all of the blocks or stages of any method or process so disclosed, may be combined in any combination, except combinations where at least some of such features, blocks and/or stages are mutually exclusive. The terms “first”, “second”, “third” and so on in the claims merely distinguish different elements and, unless otherwise stated, are not to be specifically associated with a particular order or particular numbering of elements in the disclosure.

What is claimed is:

1. A method to adjust optical density, the method comprising:
during a first printing operation, providing a first voltage to an electrode of a development assembly, wherein the developer assembly includes a current-resistant coating and is to develop print fluid with conductive particles;
contemporaneous with the providing of the first voltage to the electrode, providing a second voltage to a squeegee roller of the developer assembly;
receiving data indicative of a measurement of optical density of a first image printed utilizing the developer assembly;
during a second printing operation, if the measured optical density is outside a target optical density, contemporaneously providing the first voltage to the electrode and a third voltage to the squeegee roller to adjust image optical density.

2. The method of claim 1, wherein the received data is data utilizing a spectrometer or densimeter.

3. The method of claim 1, wherein the first image is a test image and the contemporaneous provision of the first voltage and a third voltage are to adjust image optical density of a second image that is a production image printed during the second printing operation.

4. The method of claim 1, wherein the first image is a production image and the contemporaneous provision of the first voltage and a third voltage are to adjust image optical density of the first image as printed during the second printing operation.

5. The method of claim 1, wherein the second voltage and the third voltage are less than the first voltage.

6. The method of claim 6, wherein the first voltage is between 300V and 500V, and second and third voltages are between 200V and 450V.

7. The method of claim 1, further comprising determining a prescribed amount for the third voltage, wherein the determining includes accessing a lookup table or other database that includes associations or combinations of squeegee roller voltages and electrode voltages to achieve target optical densities.

8. The method of claim 1, wherein the change in voltage provided to the squeegee roller from the second voltage to the third voltage is to cause a change in image background level.

9. The method of claim 1, further comprising, in response to receipt of data indicative that a measurement of background error detected in the printed first image is greater than a background tolerance level, contemporaneously providing the first voltage to the electrode and a third voltage to the squeegee roller to adjust background level.

10. The method of claim 1, further comprising determining a prescribed amount for the third voltage, wherein the determining includes accessing a lookup table or other database that includes associations or combinations of squeegee roller voltages and electrode voltages to achieve target background levels.

11. The method of claim 1, wherein the conductive particles are metal flakes.

12. The method of claim 1, wherein the current-resistant coating is a coating of one of the squeegee roller and a cleaner roller and is a ceramic material.

13. The method of claim 1, wherein the current-resistant coating is a polymeric current-resistant coating.

14. A developer assembly for developing print fluid with conductive particles, comprising:
a housing;
an electrode disposed within the housing;
a member with a current-resistant coating;
a squeegee roller disposed adjoining a surface of a developer roller;
the developer roller,
a first printing operation engine, to cause contemporaneous provision of a first voltage to the electrode and provision of a second voltage to the squeegee roller;
a measurement data engine, to receive data indicative of a measurement of optical density of a first image printed utilizing the developer assembly;
a second printing operation engine, to, if the measured optical density is outside a target optical density, contemporaneously provide the first voltage to the electrode and provide a third voltage to the squeegee roller to adjust image optical density.

15. A printer system, comprising:
a chargeable photoconductive element;
a writing element to selectively discharge the photoconductive element to create a latent image upon the photoconductive element;
a developer assembly to apply print fluid to the photoconductive element to develop the latent image, the developer assembly including
a member with a current-resistant coating;
a housing;
an electrode disposed within the housing;
a squeegee roller disposed adjoining a surface of a developer roller;
the developer roller;
a first printing operation engine, to cause contemporaneous provision of a first voltage to the electrode and provision of a second voltage to the squeegee roller;
a measurement data engine, to receive data originating from a color measurement device, the data indicative of a measurement of optical density of a first image printed utilizing the developer assembly;
a second printing operation engine, to, if the measured optical density is outside a target optical density, contemporaneously provide the first voltage to the electrode and provide a third voltage to the squeegee roller to adjust image optical density; and
the color measurement device.
